(19) United States
(12) Patent Application Publication
(10) Pub. No.: US 2026/0316681 A1
(43) Pub. Date: Oct. 15, 2026

(54) Digital Viewing System For A Vehicle And Method For Adjusting A Predetermined Viewing Area In A Display Image Generated By The Viewing System

(71) Applicant: MEKRA Lang GmbH & Co. KG, Ergersheim (DE)

(72) Inventors: Oliver Hutzler, Uffenheim (DE); Michael Scheffold, Bad Windsheim (DE); Andreas Enz, Burgbernheim (DE)

(73) Assignee: MEKRA Lang GmbH & Co. KG, Ergersheim (DE)

(21) Appl. No.: 19/461,431

(22) Filed: Jan. 27, 2026

(30) Foreign Application Priority Data
Jan. 31, 2025 (DE) 102025103671.3

(51) Int. Cl. B60R 1/28

(52) U.S. Cl. CPC B60R 1/28; B60R 2300/302; B60R 2300/306; B60R 2300/307

(57) ABSTRACT

A digital viewing system and method for adjusting a viewing area displayed on a display unit of the digital viewing system of a vehicle involves: capturing S1 image data of an environment of the vehicle by an image capture unit of the digital viewing system, processing S2 the captured image data, displaying S3 the processed image data as a display image with the viewing area, obtaining S4 information characteristic of a road course on which the vehicle is traveling and/or toward which it is traveling, and processing the captured image data on the obtained information about the road course such that the display image undergoes a viewing area adjustment S5a, S7, wherein the viewing area adjustment S5a, S7 is performed in the display image when the vehicle reaches a predefined trigger point located on the road course or delayed by a predefined time thereafter.

### TECHNICAL BACKGROUND

The invention relates to a digital viewing system for a vehicle (e.g. a commercial vehicle, truck, construction machinery, etc.) for displaying of predetermined viewing areas around the vehicle, and a method executable by the digital viewing system for adapting the viewing area to an expected course of a road on which the vehicle is traveling or toward which it is approaching.

### DISCUSSION OF RELATED ART

Motor vehicles are usually equipped with exterior mirrors on both sides within the driver’s field of view, which, for example, cover the side and/or rear surroundings of the motor vehicle. In commercial vehicles in particular, mirror systems consisting of several mirrors of different sizes and curvatures are required to cover specific partial areas of the commercial vehicle’s surroundings. Outside mirrors have the disadvantage that they are particularly susceptible to environmental influences and thus become dirty, icy, etc., so that the image visible on the mirror is not recognizable or only indistinctly recognizable, and then the mirror function is not adequately fulfilled.

Recently, exterior mirrors have therefore been increasingly replaced by digital viewing systems, in particular mirror replacement systems that have at least one image capture unit, for example a main camera (camera that mainly captures the main mirror field of view of a commercial vehicle) and a wide-angle camera (camera that mainly captures the wide-angle mirror field of view of a commercial vehicle). For example, such digital viewing systems, which are used as mirror replacement systems on commercial vehicles, capture the fields of view of groups II and IV in accordance with UN/ECE-R46 and display them to the driver on at least one display unit (monitor) that is visible to the driver. The display unit may have a single display area or a plurality of display areas, in which case the driver can be shown the vehicle’s surroundings in different ways in the individual display areas.

Generally, a specific area of the vehicle’s surroundings is displayed on a display unit or on each of a plurality of display areas on the display unit of such a digital viewing system during a respective driving condition, such as forward driving, reverse driving, etc. For example, when the vehicle is traveling forward, an area to the side and rear of the vehicle is displayed that corresponds to the main mirror and wide-angle mirror (fields of view II and IV according to UN/ECE-R46) in the case of mirrors. Additional digital viewing systems (camera monitor systems) can be provided, which are used, for example, when rearward driving to display the rear area of the vehicle.

In certain driving situations, it may be necessary or desirable to change an area of the vehicle’s surroundings displayed by a digital viewing system in order to better assess the traffic situation around the vehicle and display it to the driver. Adjusting the displayed field of view (viewing area) may also be desirable for certain courses (road layouts) of a road that the vehicle is approaching.

Examples of such driving situations or road layouts are 45-degree junctions at an intersection or highway on-ramps. When the vehicle is driving in these situations, it may be the case that, for example, a standard viewing area, which may be a specified field of view to the side and rear of the vehicle, does not cover the entire area that is important to the driver, does not display information that is important to the driver, or does not even show any relevant areas at all, for example, when driving onto a highway on-ramp, the driver may not be able to see the entire area that is important to the driver, or the display may not show any relevant areas at all, in order to be able to observe the traffic situation on the highway or in the area of the entrance ramp and thus ensure anticipatory and safe driving. A highway entrance or exit, for example, represents a typical predetermined road layout. Entering a highway can be regarded as a predetermined standardized driving situation. Another example is crossing intersections, where it may be desirable for the driver to have a better view into the road to be crossed.

### SUMMARY OF THE INVENTION

An object of the invention is to provide a digital viewing system and a method that make it possible to provide a driver of a motor vehicle with better information on the vehicle’s surroundings in certain driving situations and at an appropriate time, which information is helpful for an anticipatory and safe driving.

The method according to the invention is characterized in that a viewing area displayed by a display unit of a digital viewing system for a vehicle according to the invention is adjusted depending on the course of a road on which the vehicle is traveling or toward which it is approaching. The course of the road represents, in particular, an expected future course of a road on which the vehicle will continue to travel. The viewing area adjustment is such that the driver of the vehicle is shown relevant environmental information that enables to drive safely and with foresight. According to the invention, such a viewing area adjustment occurs in particular when a predefined trigger point on the course of the road is reached, or a predefined time thereafter. A trigger point is not “physically” located on the road, but is assigned to a feature present on the course of the road. Such a feature can be, for example, a traffic sign,

a specific curve radius of a road marking, a guardrail, a traffic light, a distance to an intersection, etc.

Such a trigger point is a point that indicates a change in the course of the road, whereby the predefined time is based on received in-vehicle signals, a current traffic situation, and/or a current driving situation. A trigger point for a viewing area adjustment can be, for example, reaching a specific point (coordinate) on a map, e.g., a specific point in the curve of a highway entrance ramp or reaching a specific point at or shortly before an intersection with a certain tolerance range. GPS data indicating the current position of the vehicle can be used for this purpose. This position can then be compared with map data indicating the trigger point to determine whether the trigger point has been reached. In addition to or as an alternative to GPS data, sensors (ultrasound, radar, lidar) attached to the vehicle can also be used to detect the trigger point, for example a traffic sign, a specific curve radius of a road marking, etc.

According to the invention, the image capture unit is preferably used to determine by means of the captured image data whether the trigger point has been reached. The image capture unit can be one of the image capture units of the digital viewing system or a separately provided image capture unit. Features in the captured image data that are characteristic of a road course are detected. A road course is characterized in particular by bridges, curves, ramps, junctions, blind intersections, tunnels, highway ramps, ramps onto federal highways, bicycle paths, rows of parking spaces along a road, etc., whereby this list is not exhaustive. Such information, which is characteristic of the course of the road, can be determined, for example, by evaluating navigation information relating to the vehicle’s journey, by evaluating vehicle parameters, such as whether an indicator is set or not, by receiving traffic management system information, by analyzing image data recorded from the viewing system, or similar. Features for the course of the road contain at least information about a road marking, a road edge marking, and/or a lane marking. The recognition of a specific marking or feature in the image data can indicate the reaching of the trigger point for adjusting the viewing area.

According to the invention, determining the course of the road and thus recognizing whether a trigger point has been reached can also be based on other sensors attached to the vehicle, e.g., by means of ultrasound, radar, lidar, etc. Road markings with a predetermined radius of curvature, which is characteristic of a highway entrance ramp or an intersection, for example, can indicate the presence of a trigger point.

The above-mentioned trigger point can also be combined with the driving speed of the vehicle equipped with the digital viewing system or other road users to calculate when it makes sense to adjust the field of view (viewing area) for the driver. This means that when driving onto a highway in a traffic jam, the viewing area can be adjusted later when the speed drops below a certain level, as the driver has significantly more time to get an overview of the image information displayed to them, compared to a situation where the vehicle is entering the acceleration lane at high speed. As mentioned above, a traffic jam situation can be detected, for example, by image recognition or evaluation of sensor signals.

In addition or alternatively, the method according to the invention reads pre-stored road map data from a memory in order to determine the information characteristic of the road course, wherein the road map data comprises at least one elevation information of the road course, type of road course (junction, highway entrance, intersection, bridges, tunnels, etc. ), an angular relationship between two converging roads, a road curve, and/or another feature mentioned above for a road course. The road map can be stored in advance in a memory provided in the vehicle and used, for example, for navigation, or can be made available wirelessly or wired from another system.

According to an advantageous further development, the method according to the invention can determine features in the captured image data that are characteristic of a current traffic situation, whereby such features comprise at least information about other road users, their distance from each other or from the vehicle itself, and/or their speed. By means of such features, it can be determined whether or when a viewing area adjustment is made or not, and/or the information can be used to warn the driver if, for example, a dangerous traffic situation or the like could be imminent. The information can also be used, for example, to detect slow-moving traffic on a highway onto which the vehicle is driving on. In this case, for example, the adjustment of the viewing area can be made more slowly, as the vehicle is traveling slowly and the driver therefore has more time to assess the current situation, as mentioned above.

The method according to the invention advantageously receives, in addition to vehicle-external signals vehicle-internal signals, advantageously from an existing vehicle network (e.g., CAN bus, LIN, Ethernet, etc.), and, for example, signals relating to the speed, acceleration, steering wheel angle, deflection angle between tractor and trailer of a commercial vehicle, etc. Such information from vehicle-internal signals can be used to determine information about the course of the road in order to determine whether a dangerous traffic situation could exist and/or to determine whether and how a viewing area adjustment should be made.

According to an advantageous further development, the method according to the invention uses not only information about the course of the road for adjusting the field of view, but also the above-mentioned information about the traffic situation or vehicle-internal signals and vehicle-external signals. The method according to the invention therefore processes the captured image data depending on the information about the course of the road and additionally depending on the current traffic situation and/or the received vehicle-internal signals such that the display image shown on the display unit undergoes the adjustment of the viewing area at a given point in time.

The method according to the invention can in particular perform one or more of the following steps to adjust the viewing area: scaling the image data such that the display image shows more or less of the vehicle’s surroundings, cropping the display image such that more or less of the vehicle’s surroundings is shown, changing a readout area on the image sensor used for the display image such that the vehicle’s surroundings shown on the display image are shifted, and/or changing an image division (splitting) of the display image such that different areas of the surroundings are displayed in different display areas or image areas of the display image. This can be done, for example, either by taking (reading) different or adjusted areas of the image data from the image sensor, or by always taking the same raw data from the image sensor, but then selecting the areas to be displayed by processing the raw data.

When adjusting the viewing area by changing the area readout from the image sensor of the image capture unit, the readout area on the image sensor, i.e., the local position of the readout area on the image sensor, is changed. The number of pixels read out may vary or remain the same. Furthermore, the size of the readout area can also be changed to adjust the viewing area accordingly. If the display image on the display unit shows several “individual” images, i.e., the display image has different display or image areas, the scaling can be different in different display areas or image areas, i.e., the image ratio of image sensor pixels and monitor pixels can be different. Scaling is a measure of how many image sensor pixels are displayed on a monitor pixel. Scaling the image also changes the displayed image area. It is also possible to adjust the viewing area by reading out the entire image and then adjusting the area used for display by the image processing unit. Regardless of how the viewing area adjustment is made, when the viewing area is expanded, a larger part of the sensor is read out or at least used for display, which can be useful, for example, when entering a highway.

The viewing area adjustment can be performed in addition to or as an alternative to the above-mentioned digital adjustment of the field of view such that the method according to the invention controls, in accordance with a further development, an adjustment mechanism of a camera arm attached to the vehicle in order to adjust the relative position between the image capture unit and the vehicle, so that the display image shown on the display unit can undergo the viewing area adjustment.

The above described method according to the invention can be performed by a digital viewing system for a vehicle.

Such a viewing system according to the invention comprises an image capture unit that can be attached to the vehicle and is adapted to capture image data of the vehicle’s surroundings, an image data processing unit adapted to process the image data captured by the image capture unit, a display unit visible to a driver of the vehicle, on which the image data captured by the image capture unit and processed by the image data processing unit is displayed to the user as a display image with the predetermined viewing area, a unit for obtaining information that is characteristic of the course of a road on which the vehicle is traveling and/or toward which it is approaching, wherein the image data processing unit is adapted to process the image data captured by the image capture unit at least depending on the determined information about the course of the road such that the display image shown to the user on the display unit undergoes a viewing area (field of view) adjustment. As described in the method according to the invention method described above, the viewing area adjustment can advantageously be made directly at or after a predefined time after reaching a trigger point that is characteristic of a change in the course of the road.

Such a trigger point is a point that indicates a change in the course of the road, whereby the predefined time is based on received vehicle-internal signals, a current traffic situation, and/or a current driving situation. A trigger point for a viewing area adjustment can be, for example, reaching a specific point (coordinate) on a map, e.g., a specific point in the curve of a highway entrance ramp or reaching a specific point at or shortly before an intersection with a certain tolerance range. GPS data indicating the current position of the vehicle can be used for this purpose. This position can then be compared with map data indicating the trigger point to determine whether the trigger point has been reached. In addition to or as an alternative to GPS data, sensors (ultrasound, radar, lidar) attached to the vehicle can also be used to detect the trigger point, for example a traffic sign, a specific curve radius of a road marking, etc.

The image processing unit of the digital viewing system is adapted to use the captured image data to determine whether the trigger point has been reached. In doing so, features in the captured image data that are characteristic of a road course are detected. A road course is characterized in particular by bridges, curves, ramps, junctions, blind intersections, tunnels, highway ramps, ramps onto federal highways, bicycle paths, parking rows along a road, etc., whereby this list is not exhaustive. Such information, which is characteristic of the course of the road, can be determined, for example, by evaluating navigation information relating to the vehicle’s journey, by evaluating vehicle parameters, such as whether or not an indicator is set, by receiving traffic management system information, by analyzing recorded image data from the vision system, or similar. The features for the course of the road contain at least information about road marking, a road edge marking, and/or a lane marking. The detection of a specific marking or feature in the image data can indicate the reaching of the trigger point for adjusting the viewing area.

According to a preferred embodiment, the digital viewing system includes additional sensors for determining the course of the road and thus for detecting whether a trigger point has been reached. Preferably, these sensors (ultrasound, radar, lidar, etc.) are attached to the vehicle and adapted to detect, for example, lane markings having a predetermined curvature radius that is characteristic of a highway entrance ramp or an intersection, for example, for the presence of a trigger point.

The above-mentioned trigger point can also be combined with the driving speed of the vehicle in which the digital vision system is installed, or with other road users, in order to calculate when it makes sense to adjust the viewing area for the driver. For example, when driving on a road entrance in a traffic jam situation, the adjustment of the viewing area can be made later when the speed falls below a certain value, as the driver has significantly more time to get an overview to obtain information about the images displayed to him, compared to a situation in which the vehicle enters the acceleration lane at high speed. As mentioned above, a traffic jam situation can be detected, for example, by image recognition or evaluation of sensor signals.

According to a preferred embodiment of the digital vision system, it includes a memory that stores road map data, wherein the road map data comprises at least one of elevation information of the road layout, type of road layout (junction, highway entrance, intersection, bridges, tunnels, etc. ), an angular relationship between two converging roads, a road curve, and/or another feature mentioned above for a road course.

According to a preferred embodiment, predetermined trigger points can be defined and stored in the above-mentioned memory. A separate memory can be provided for this purpose. A comparison unit can be provided according to a preferred embodiment, which compares detected features of the road with these stored trigger points to determine whether the vehicle has passed a trigger point.

According to an advantageous further development, the image processing unit is adapted to determine features in the captured image data that are characteristic of a current traffic situation, whereby such features comprise at least information about other road users, their distance from each other or from the vehicle itself, and/or their speed. With the help of such features, it can be determined whether or when a viewing area adjustment is made or not, and/or the information can be used to warn the driver if, for example, a dangerous traffic situation or the like could be imminent. The information can also be used, for example, to detect slow-moving traffic on a highway onto which the vehicle is entering. In this case, for example, the viewing area adjustment can be slower because the vehicle is traveling more slowly and the driver therefore has more time to assess the current situation, as mentioned above.

According to a preferred embodiment, the unit of the digital vision system is adapted to receive not only vehicle-external signals but also vehicle-internal signals, advantageously from an existing vehicle network (e.g., CAN bus, LIN, Ethernet, etc.), for example signals relating to the speed, acceleration, steering wheel angle, deflection angle between tractor and trailer of a commercial vehicle, etc. Such information from vehicle-internal signals can be used to determine information about the road layout in order to determine whether a dangerous traffic situation exists, and/or to determine whether and how a viewing area adjustment should be made.

According to a preferred embodiment of the invention, the image processing unit is adapted to adjust the viewing area, in particular by one or more of the following steps: scaling the image data so that the display image shows more or less of the vehicle’s surroundings, cropping the display image so that more or less of the vehicle’s surroundings is shown, changing an area on the image sensor readout used for the display image such that the vehicle’s surroundings shown on the display image are shifted, and/or changing an image division of the display image such that different areas of the surroundings are displayed in different display areas or image areas of the display image. This can be done, for example, either by taking (reading) different or adapted areas of the image data from the image sensor, or by always taking the same raw data from the image sensor, but then selecting the areas to be displayed by processing the raw data.

When adjusting the viewing area by changing the readout area on the image sensor of the image capture unit, the readout area on the image sensor, i.e., the local position of the readout area on the image sensor, is changed. The number of pixels read out may vary or remain the same. Furthermore, the size of the readout area can also be changed to adjust the viewing area accordingly. If the display image on the display unit shows several “single/individual” images, i.e., the display image has different display areas or image areas, the scaling can be different in different display areas or image areas, i.e., the image ratio of image sensor pixels and monitor pixels can be different. Scaling is a measure of how many image sensor pixels are displayed on a monitor pixel. Scaling the image also changes the displayed field of view. It is also possible to adjust the field of view by reading out the entire image and then adjusting the area used for display by the image processing unit. Regardless of how the viewing area adjustment is made, when the field of view is expanded, a larger part of the sensor is read out or at least used for display, which can be useful, for example, when entering a highway.

According to a preferred embodiment, the digital viewing system includes an adjustment mechanism for viewing area adjustment, in addition to or as an alternative to the above-mentioned digital adjustment of the viewing area. This adjustment mechanism controls a camera arm attached to the vehicle in order to adjust the relative position between the image capture unit and the vehicle so that the display image shown on the display unit undergoes the viewing area adjustment.

The digital viewing system may comprise one or more image capture units, one or more image data processing units, and one or more display units. The one or more image data processing units may be integrated in the one image capture unit or the multiple image capture units, and/or in the one display unit or the multiple display units, and/or provided separately therefrom, for example within the framework of a general on-board computer (ECU).

According to a further development, the digital vision system according to the invention includes a human-machine interface via which the adjustment of the field of view in the display image can be predefined, confirmed, rejected, or reversed depending on the course of the road, the traffic situation, and/or the driving situation, for example by a driver. This allows preconfigured viewing area adjustments that are adapted to specific standard traffic situations, such as entering a highway or crossing an intersection, to be suggested to the driver. These can be easily accepted or rejected by the driver, or the driver can adapt them to his or her individual needs.

As mentioned above, according to a preferred embodiment, the digital viewing system comprises a camera arm to which the at least one image capture unit is attached. The camera arm is coupled to an adjustment mechanism for changing the relative position between at least one of the image capture units and the vehicle such that the display image shown to the user on the display unit undergoes the viewing area adjustment. This means that, as an alternative or in addition to the above-mentioned digital viewing area adjustment, a viewing area adjustment can also be carried out by mechanically adjusting the position, location, and/or orientation of the image capture unit.

The digital viewing system according to the invention is suitable as a mirror replacement system for a vehicle, in particular preferably approved according to UN/ECE-R46, wherein the at least one image capture unit is approved according to UN/ECE-R158, UN/ECE-R159, and/or R151.

### BRIEF DESCRIPTION OF THE FIGURES

Preferred embodiments of the invention are described below with reference to the accompanying figures, wherein the same reference signs denote the same components or steps.

FIG. 1 shows a schematical illustration of an embodiment of a digital viewing system according to the invention;

FIG. 2 shows a schematical illustration of the interior of a vehicle’s cockpit in which the digital viewing system is used;

FIG. 3 shows a schematical side/plan view of a vehicle in which the digital viewing system is used;

FIG. 4 shows a flow diagram of a method of the invention according to a first embodiment;

FIG. 5 shows a flow diagram of a method of the invention according to a second embodiment;

FIG. 6 shows a schematic illustration of a first driving situation with an example of a course of road;

FIG. 6a shows a display image of field of view corresponding to FIG. 6;

FIG. 7 shows a schematic illustration of a driving situation with the course of road according to FIG. 6 having an adapted field of view;

FIG. 7a shows a display image with the adapted field of view corresponding to FIG. 7;

FIG. 8 shows A schematic illustration of the driving situation with the course of the road according to FIG. 6 with a field of view that has been alternatively adjusted compared to FIG. 7a;

FIG. 8a shows a display image with the alternatively adjusted field of view corresponding to FIG. 8;

FIG. 9 shows is a schematic illustration of a second driving situation with an exemplary road layout;

FIG. 9a shows a display image with the field of view corresponding to FIG. 9;

FIG. 10 shows a schematic illustration of the driving situation with the road layout according to FIG. 9; and

FIG. 10a shows a display image with the adjusted field of view corresponding to FIG. 10.

### DETAILED DESCRIPTION OF THE DISCLOSED EMBODIMENTS

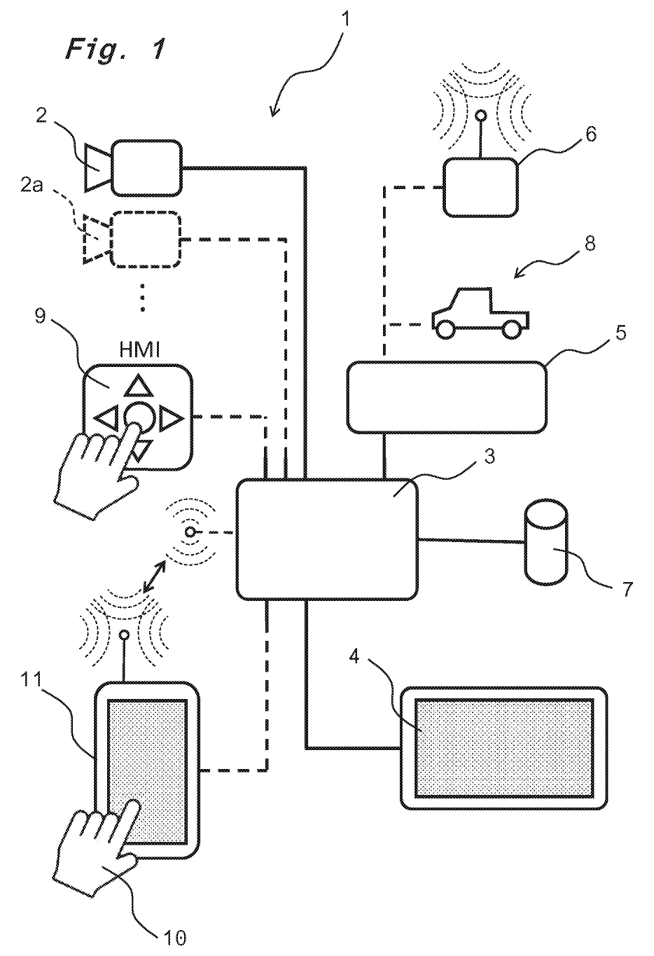

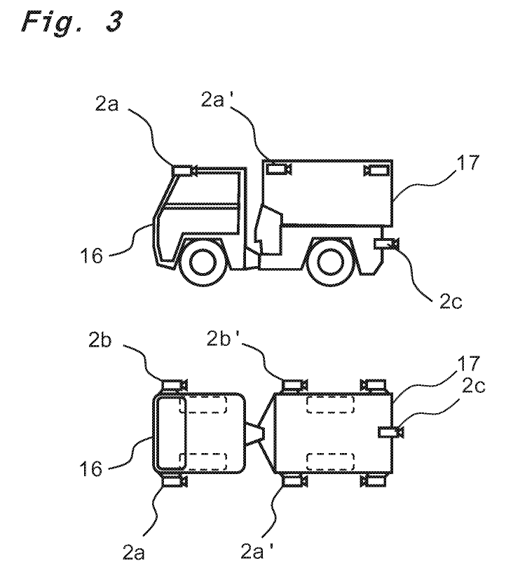

FIG. 1 shows a schematic representation of an embodiment of a digital viewing system 1 according to the invention. According to this embodiment, the viewing system 1 includes an image capture unit 2, which is one of a plurality of image capture units 2, 2a. FIG. 1 also shows a second image capture unit 2a. The image capture units 2, 2a are preferably mounted on the outside of a vehicle (not shown in FIG. 1) and capture images of the vehicle’s surroundings, as described later with reference to FIG. 3.

FIG. 1 also shows an image processing unit 3, which is connected to the image capture units 2, 2a, respectively, receives image data (raw image data) from them, and processes it. The image data processed by the image processing unit 3, for example, is displayed on a display unit 4 as a display image, which means that a predetermined field of view (viewing area), i.e., an area of the vehicle’s surroundings, is displayed on the display unit 4, as described later. In this context, predetermined viewing area means that an area is displayed that is displayed by default for a respective driving situation, such as forward driving, for example.

FIG. 1 also shows a unit 5 that is coupled to a satellite-based positioning system 6 (e.g., GPS system) that determines the current position of the vehicle and transmits it to the unit 5. According to the preferred embodiment of the digital viewing system 1, the positioning system 6 is merely optional and can be omitted. The unit 5 is also adapted to receive information that is characteristic of the course of a road on which the vehicle is traveling or toward which the vehicle is approaching.

According to the viewing system 1 shown in FIG. 1, the unit 5 receives information about the course of the road based on characteristic features for a road course, which are determined from image data captured by the image capture unit or units 2, 2a by the image processing unit 3. Characteristics of the road course comprise, for example, information about a road marking, a road edge marking and/or a lane marking, etc.

As shown in FIG. 1, the image processing unit 3 is connected to a memory 7 in which road map data is stored in advance. The memory 7 may be the same memory that is also accessed by a navigation system of the vehicle to obtain road map data, or it may be a separate memory. Furthermore, it is possible that the memory 7 is not provided on or in the vehicle, but is located externally, and the digital vision system is connected to and communicates with the memory 7 via wireless data communication. The read road map data can be used by the unit 5 to obtain information about the current course of the road. Road map data contains, for example, at least one of elevation information of the road layout, type of road layout, angular relationship between two converging roads and/or a road curvature, etc.

FIG. 1 also shows a road user 8. The unit 5 is adapted to receive further information from the other road user 8, which forms the basis for determining the course of the road or for the manner and timing of an adjustment of a viewing area of a display image shown on display unit 4.

FIG. 1 also shows a human-machine interface 9 connected to the image processing unit 3. According to the invention, viewing area adjustments are predefined depending on the course of the road, traffic situation and/or driving situation. Such a predefined setting can be stored, for example, in the memory 7 or in a separate, not shown memory. Via the human-machine interface 9, a user 10, in particular the driver of the vehicle in which the digital vision system 1 is installed, can confirm, reject, or cancel such a predefined viewing area adjustment in the display image on the display unit 4 depending on the course of the road, the traffic situation, and/or the driving situation. For example, the user 10, in particular the driver or workshop personnel, can change a factory-preset viewing area adjustment and save the changed viewing area adjustment.

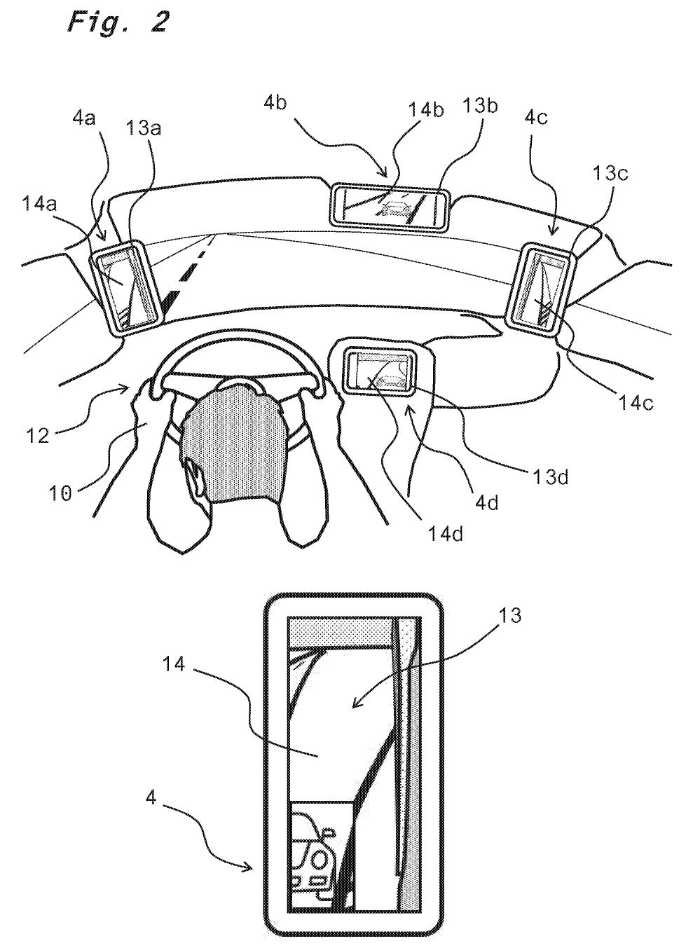

FIG. 1 also shows a touchscreen 11 that is wirelessly coupled to the image processing unit 3 and via which the user 10 can, for example, select different image capture units 2, 2a whose image data is to be used for the display image. The touchscreen 11 can take over the function of the human-machine interface 9. Via the touchscreen 11, the user 10 can also specify which display images with which viewing areas are to be displayed on which display unit 4, as shown in FIG. 2.

FIG. 2 shows a schematic interior view of a vehicle cockpit 12 in which the digital viewing system 1 is used. As shown in FIG. 2, several display units 4a-4d are arranged in the cockpit such that they are clearly visible to the driver (user 10). On each of the display units 4a-4d, the driver is shown a display image 13a-13d with a corresponding viewing area 14a-14d. The display unit 4a shows the driver the left rear side area of the vehicle (field of view II), which is captured, for example, by the image capture unit 2a, 2a’ shown in FIG. 3. On the display unit 4c, the driver is shown the right rear side area of the vehicle (field of view II), which is captured, for example, by the image capture unit 2b, 2b’ shown in FIG. 3. The display unit 4d shows the driver the rear area of the vehicle, which is captured, for example, by the image capture unit 2c shown in FIG. 3. The display unit 4b shows the driver the front area of the vehicle.

FIG. 3 shows a schematic side view or top view of a vehicle 15 in which the digital viewing system 1 is used. In this embodiment, the vehicle 15 is a commercial vehicle with a tractor unit 16 and a trailer 17. As shown in FIG. 3, a plurality of image capture units 2 are attached to the vehicle 15 in order to capture image data from the surroundings of the vehicle 15 and to display corresponding display images 13 with a corresponding (adapted) viewing area 14 to the driver of the vehicle 15 on one or more display units 4, as shown in FIG. 2. The image capture units 2a and 2b, as shown in FIG. 3, may also capture an area in front of the vehicle in accordance with a preferred embodiment in order to determine the course of the road or the trigger point from the captured image data. In addition or alternatively, further image capture units and sensors (not shown) may be used for this purpose, as described above.

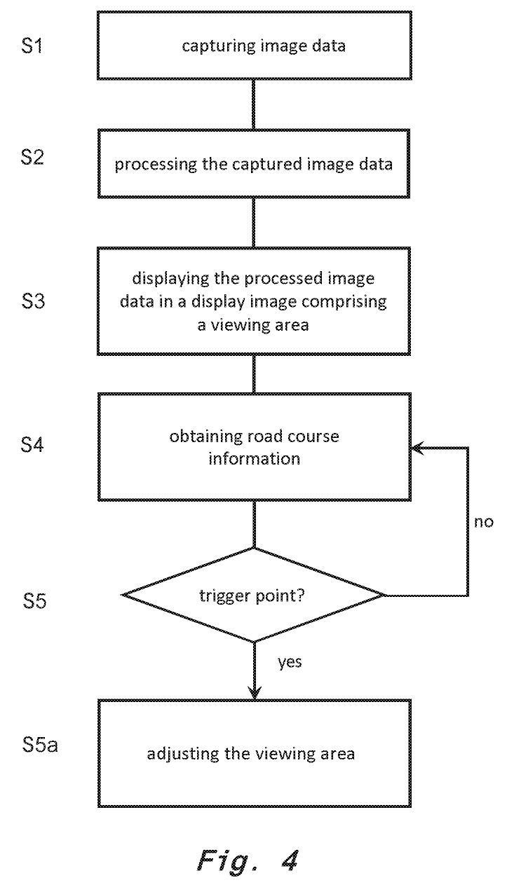

FIG. 4 schematically shows a flowchart of a method according to the invention in accordance with a first embodiment that can be executed by the digital viewing system 1.

In step S1, at least one image capture unit 2 of the viewing system 1 captures image data of the surrounding of the vehicle 15. In step S2, this data is processed by the image processing unit 3 for display as a display image 13 representing a given viewing area 14, in step S3. The method according to the invention in this embodiment continuously obtains road course information in step S4, for example via the above-mentioned unit 5.

In step S5, it is determined whether the vehicle has reached a trigger point that indicates a change in the course of the road, for example, the junction at an intersection or the entrance to a motorway. Specifically, it is determined whether a trigger point that lies on an expected course of the road and is relevant for initiating an adjustment of the field of view is reached by the vehicle.

In step S5a, according to this embodiment, immediately after detecting the trigger point, the image data processing unit 3 adjusts the image data captured by the at least one image capture unit 2 at least depending on the determined information about the course of the road such that the display image 13 shown to the user on the display unit 4 undergoes a viewing area adjustment.

FIG. 5 schematically shows a flowchart of a method according to the invention in accordance with a second embodiment that can be performed by the digital viewing system 1.

The second embodiment of the method according to the invention differs from the first embodiment of FIG. 4 in that, in step S4a, additional vehicle-internal and/or vehicle-external data is received and this is taken into account in addition to the received road course information when adjusting the viewing area. Vehicle-external data comprises, for example, in addition to road course information, information about other road users 8, their speed, distance, etc., whereas vehicle-internal data relates to the speed, acceleration, steering angle, etc. of the vehicle 15 in which the digital viewing system 1 is installed.

After detecting a trigger point, the method according to this embodiment continues in step S6, where a timer is started whose start value depends on the vehicle-internal and/or vehicle-external data received in step S4a. Only after a predefined time has elapsed does the method continue in step S7 and the adjustment of the field of view is carried out. This allows, for example, the timing of the adjustment of the viewing area to be linked to the speed of the vehicle, since at higher speeds (vehicle-internal data) the adjustment usually has to be made more quickly. Furthermore, in the event of traffic jams or heavy traffic, for example (vehicle-external data) on a highway, the adjustment of the field of view can be delayed, e.g., when entering the highway. The same applies to other traffic situations or driving situations.

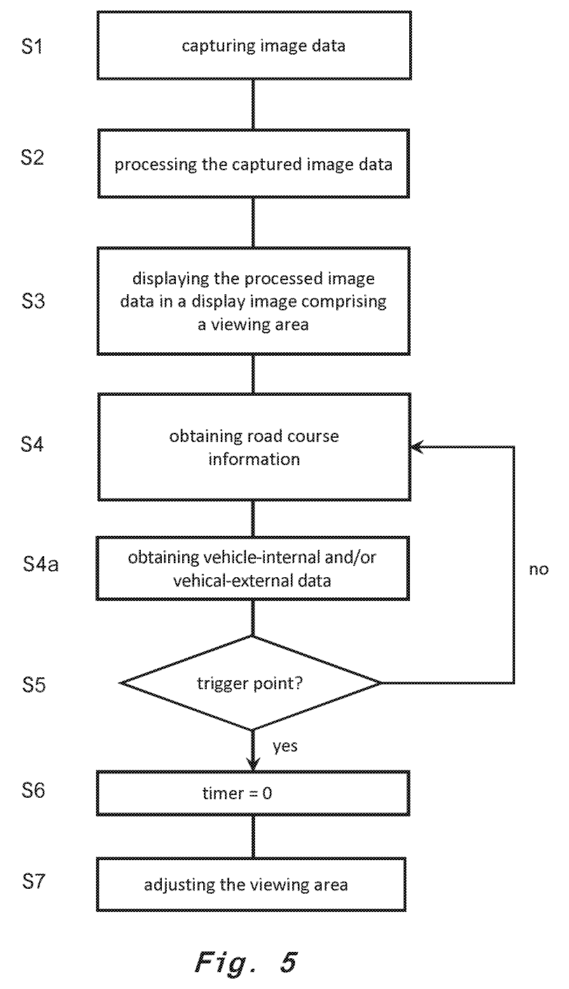

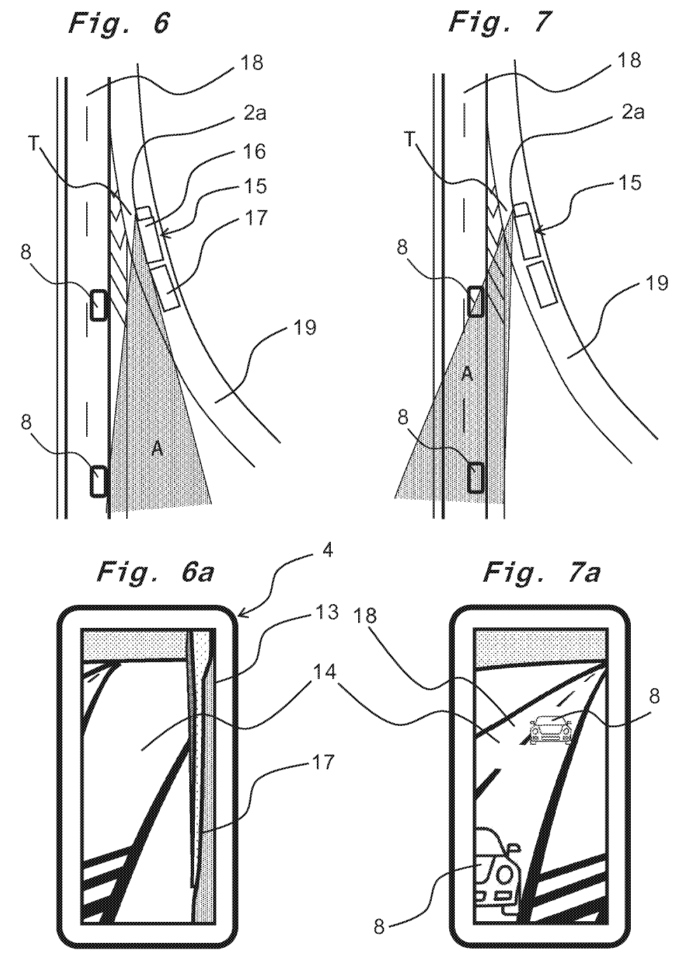

FIG. 6 shows a schematic representation of an initial driving situation with an example road layout (road course). Specifically, a vehicle 15 with a tractor unit 16 and trailer 17 is driving onto a highway 18. The left front image capture unit 2 captures the area A to the side behind the vehicle 15. This essentially includes, for example, the legally prescribed field of view II. The image data of area A captured by the image capture unit 2 is processed as described above and displayed on the display unit 4 as display image 13 with the viewing area 14 corresponding to the area A in FIG. 6.

As shown in FIG. 6, there are other road users 8 on the highway. In order to provide the driver of the vehicle with better information in the display image 13, enabling him to observe the traffic on the highway 18 at the entrance ramp in advance, the viewing area 14 is adjusted in accordance with the invention depending on the course of the road (here: highway entrance ramp 19) so that the other road users 8 appear in the viewing area 14 and can be perceived by the driver, as shown in FIGS. 7 and 7a. Such a shift of the viewing area can be achieved, for example, by changing an area on the image sensor of the image capture unit 2 which is read out, as described above. In doing so, the readout area of the image sensor, i.e., the local position of the readout area of the image sensor, is changed. In addition or alternatively, the viewing area 14 can be shifted from the area shown in FIGS. 6 and 6a to the area shown in FIGS. 7 and 7a by changing the adjustment unit of the camera arm described above on which the image capture unit 2 is mounted.

According to the invention, the above adjustment of the viewing area 14 takes place when a trigger point T, as shown in FIG. 6, is reached. As described above, this trigger point T is located on a road on which the vehicle 16 is traveling or approaching and can, for example, be defined by the radius of curvature of a lane marking on the highway entrance ramp, which is determined from image data or detected by other sensors on the vehicle, as described above.

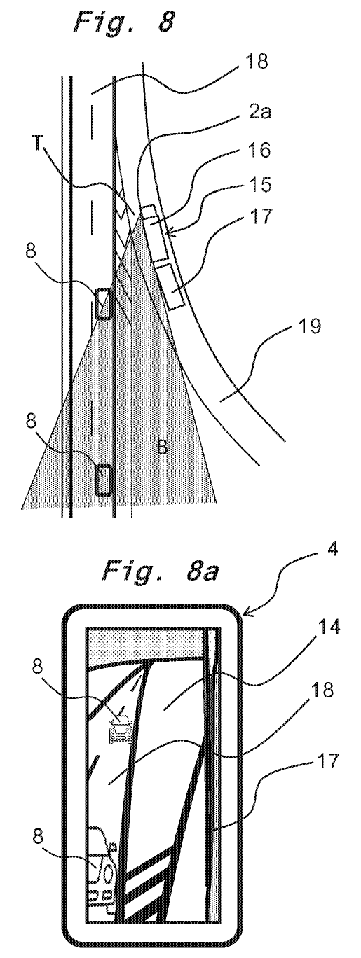

FIG. 8 shows a schematic representation of the driving situation with the course of road (road layout) according to FIGS. 6 and 7 with an alternatively adjusted viewing area 14. As shown in FIGS. 8, 8a, according to this embodiment, the area A of FIG. 6 is not shifted but enlarged. The viewing area A of FIG. 6 is thus extended to the viewing area B shown in FIG. 8. According to this viewing area adjustment, the driver of vehicle 15 can not only perceive the road users 8 already driving on the highway, but also continue to perceive the legally prescribed field of view II. The display image 13 shown in FIG. 8a can be a panoramic image obtained by appropriately scaling the readout areas of the image sensor of the image capture unit 2. Alternatively, a larger readout area of the image sensor can be used, as described above.

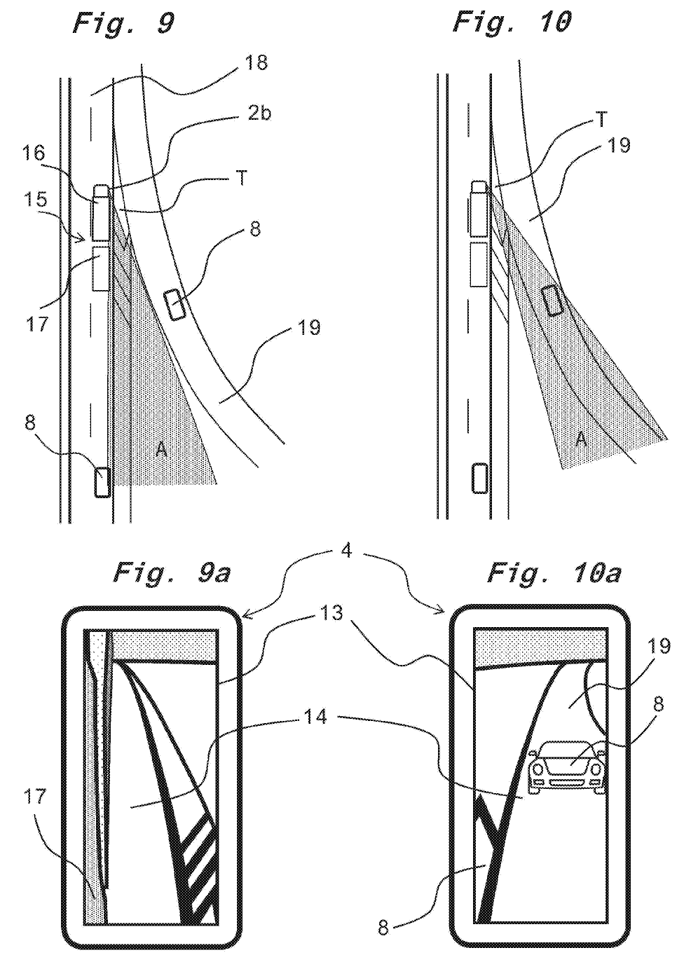

FIG. 10 shows a schematic representation of a second driving situation with the road layout shown in FIGS. 7-9. In contrast to the situation shown in FIGS. 6 and 7, the vehicle 15 is on the highway 18, and image data captured by an image capture unit 2 on the right side of vehicle 15 is processed such that the display image 13 shown on the display unit 4 has a viewing area 14 that is adjusted so that the driver of vehicle 15 can perceive road users entering the highway. Here, too, the adjustment is made when the trigger point T is reached or detected, which in this case is, for example, a feature that is characteristic of the presence of a highway entrance.

1. A method for adjusting a viewing area displayed on a display unit of a digital viewing system of a vehicle, comprising the steps of: capturing (S1) image data of a surrounding of the vehicle by an image capture unit of the digital viewing system, processing (S2) the captured image data by an image data processing unit, displaying (S3) the processed image data on the display unit as a display image comprising the viewing area, obtaining (S4) information that is characteristic of a road course of a road on which the vehicle is traveling and/or toward which it is traveling, and processing the captured image data at least as a function of the obtained information about the road course such that the display image displayed on the display unit undergoes a viewing area adjustment (S5a, S7), wherein the viewing area adjustment (S5a, S7) is performed in the display image when the vehicle reaches a predefined trigger point located on the road course, or delayed by a predefined time thereafter.

2. The method according to claim 1, wherein obtaining (S4) the information about the road course comprises the steps of: determining features in the captured image data that are characteristic of the road layout, and/or determining features in the captured image data that are characteristic of a current traffic situation and/or driving situation.

3. The method according to claim 1, wherein obtaining (S4) the information about the road layout comprises the steps of: receiving vehicle-internal signals from the vehicle and/or vehicle-external signals that comprise information about characteristics that are typical of the road layout, traffic situation, and/or driving situation, from sensors attached to the vehicle and/or a vehicle-internal driver assistance system.

4. The method according to claim 2, wherein the features for the course of the road comprise at least information about a road marking, a roadside marking, and/or a lane marking, and the features for the current traffic situation and/or driving situation comprise at least information about other road users, distance information, and/or speed information.

5. The method according to claim 1, wherein obtaining (S4) the information about the course of the road comprises the steps of: determining the current position of the vehicle, and reading out pre-stored road map data from a memory based on the determined current position.

6. The method according to claim 5, wherein the road map data comprises at least one of elevation information of the course of the road, type of course of the road, and angular relationship between two converging roads, and/or a road curvature.

7. The method according to claim 1, further comprising: processing the captured image data depending on the current traffic situation, the driving situation, the received vehicle-internal and/or vehicle-external signals such that the display image shown on the display unit undergoes the viewing area adjustment.

8. The method according to claim 1, wherein the predefined time for the viewing area adjustment in the display image is based on the course of the road, the received vehicle-internal signals, the vehicle-external signals, the current traffic situation and/or the current driving situation.

9. The method according to claim 1, wherein the viewing area adjustment (S6) in the display image comprises the following steps: scaling the image data such that a larger or smaller area of the vehicle’s surroundings is displayed in the display image, changing a readout area of an image sensor of the image capture unit used for the display image such that the vehicle’s surroundings shown on the display image are shifted, and/or changing an image division of the display image such that different areas of the surroundings are displayed in different image areas of the display image.

10. The method according to claim 1, further comprising: controlling an adjustment mechanism of a camera arm attached to the vehicle to adjust the relative position between the image capture unit and the vehicle so that the display image shown on the display unit undergoes the viewing area adjustment.

11. A digital viewing system for a vehicle, comprising:
an image capture unit mounted on the vehicle and adapted to capture image data of the surroundings of the vehicle,
an image data processing unit adapted to process the image data captured by the image capture unit,
a display unit visible to a user of the vehicle, on which the image data captured by the image capture unit and processed by the image data processing unit is displayed as a display image with a viewing area to the user,
a unit for obtaining information that is characteristic of a road course of a road on which the vehicle is traveling and/or toward which it is traveling, wherein the image data processing unit is adapted to process the image data captured by the image capture unit at least as a function of the information obtained about the course of the road such that the display image displayed to the user on the display unit undergoes a viewing area adjustment, wherein the viewing area adjustment is made in the display image when the vehicle reaches a predefined trigger point located on the road course, or is delayed by a predefined time thereafter.

12. The digital viewing system according to claim 11, wherein the image data processing unit is adapted to determine features in the captured image data that are characteristic of the course of the road, and/or the image data processing unit is adapted to determine features in the captured image data that are characteristic of a current traffic situation and/or driving situation.

13. The digital viewing system according to claim 12, wherein the features for the course of the road comprise at least information about a road marking, a road side marking and/or a lane marking, and the features for the current traffic situation and/or driving situation comprise at least information about other road users, distance information and/or speed information.

14. The digital viewing system according to claim 11, wherein the unit is adapted to receive vehicle-internal and/or vehicle-external signals comprising information about characteristics that are indicative of the course of the road, traffic situation and/or driving situation, from sensors attached to the vehicle and/or a vehicle-internal driver assistance system.

15. The digital viewing system according to claim 11, wherein the unit is adapted to receive the current position of the vehicle and to read out pre-stored road map data from a memory.

16. The digital viewing system according to claim 15, wherein the road map data comprises at least elevation information of the road course, type of road course, angular relationship between two converging roads, and/or road curvature.

17. The digital viewing system according to claim 11, wherein the image data processing unit is adapted for processing the captured image data depending on the current traffic situation, the driving situation, the received vehicle-internal signals and/or vehicle-external signals such that the display image shown on the display unit undergoes the viewing area adjustment.

18. The digital viewing system according to claim 11, wherein the predefined time for viewing area adjustment in the display image is based on the course of the road, the vehicle-internal signals, the vehicle-external signals, the current traffic situation, and/or the current driving situation.

19. The digital viewing system according to claim 11, wherein the image processing unit is adapted to perform the viewing area adjustment:
by scaling the image data such that a larger or smaller area of the vehicle’s surroundings is displayed in the display image;
by changing a readout area of an image sensor of the image capture unit used for the display image such that the vehicle’s surroundings shown on the display image is shifted, and/or by changing an image division of the display image such that different areas of the surroundings are displayed in different image areas of the display image.

20. The digital viewing system according to claim 11, further comprising a human-machine interface via which the viewing area adjustment in the display image can be confirmed, rejected, or canceled depending on the course of the road, vehicle-internal signals, vehicle-external signals, traffic situation, and/or driving situation.

21. The digital viewing system according to claim 11, further comprising a camera arm attached to the vehicle and having an adjustment mechanism for changing the relative position between the image capture unit and the vehicle such that the display image shown to the user on the display unit undergoes the viewing area adjustment.

22. The digital viewing system according to claim 11, which is approved according to UN/ECE-R46, wherein the image capture unit is approved according to UN/ECE-R158, UN/ECE-R159, and/or R151.
